(19) United States
(12) Patent Application Publication
(10) Pub. No.: US 2022/0274801 A1
(43) Pub. Date: Sep. 1, 2022

(54) DEVICE FOR STORING AT LEAST ONE CABLE

(71) Applicant: Roland Gatt, Ampass (AT)

(72) Inventors: Roland GATT, Ampass (AT); Juri GATT, Ampass (AT); Levi GATT, Ampass (AT); Sami GATT, Ampass (AT); Ari GATT, Ampass (AT)

(21) Appl. No.: 17/747,640

(22) Filed: May 18, 2022

Related U.S. Application Data
(63) Continuation of application No. PCT/AT2020/060390, filed on Nov. 5, 2020.

(30) Foreign Application Priority Data
Nov. 19, 2019 (AT) A 50999/2019

(51) Int. Cl. B65H 75/36; H02G 11/00; A47B 21/06

(52) U.S. Cl. CPC B65H 75/368; H02G 11/006; A47B 21/06; B65H 2701/34; B65H 2406/14

(57) ABSTRACT

A device for storing at least one cable, in particular a cable retractor, includes: a housing; at least one receiving piston that extends in the housing, preferably rectilinearly; at least one deflection roller that is mounted axially rotatably on the at least one receiving piston and is intended to guide cables; and at least one discharge valve for discharging air between a lower side of the at least one receiving piston and the housing into an outer region of the device. The device also includes at least one admission valve for admitting air from the outer region of the device into the region between the lower side of the at least one receiving piston and the housing.

### BACKGROUND OF THE INVENTION

The invention relates to a device for storing at least one cable, in particular a cable retractor, comprising
a housing,
at least one receiving piston guided in the housing, preferably rectilinearly,
at least one deflection roller, mounted axially rotatably on the at least one receiving piston, for guiding cables, and
at least one discharge valve for discharging air between a lower side of the at least one receiving piston and the housing into an outer region of the device.
   Furthermore, the invention relates to such a device with at least one cable, as well as a piece of furniture, in particular a table, with at least one such device.

A device for storing a cable is already known from the document US 2013/0243233 A1, wherein an outer diameter of a piston which is slightly smaller than a housing defines a gap which, via the resultant air resistance, generates a damping effect during a lowering process caused by the weight of the piston. Air can escape via the gap, and a relief valve is arranged on the housing. A cable is guided over a pulley which is connected to the piston, and the pulley is vertically movable in the housing.

A disadvantage of the state of the art is that only one relief valve is provided for controlling the air resistance and air can escape continuously via the gap between piston and housing. Furthermore, the lowering of the piston is only slowed down by the air resistance until the cable cannot be lowered further into the cylinder due to a widening at one end of the cable. This results in a reduction of the cable life.

### SUMMARY OF THE INVENTION

The object of the present invention is therefore to specify a device for storing at least one cable that is improved compared with the state of the art, in which the disadvantages of the state of the art are at least partially remedied. The invention is characterized in particular by a regulated air-admission and air-discharge structure, in order to effectively damp the lowering process of the piston in the housing.

According to the invention, at least one admission valve is provided for admitting air from the outer region of the device into the region between the lower side of the at least one receiving piston and the housing.

This makes it possible firstly for a harmonic lowering process of the receiving piston in the housing due to gravity to be guaranteed without increased effort and for a vertical movement of the receiving piston to be able to be controlled via the at least one discharge valve and the at least one admission valve.

Added to this is the positive property that the at least one admission valve and the at least one discharge valve gently promote the lowering process and a raising process of the receiving piston and the components arranged thereon in such a way that the life of the components involved in the lowering or raising process is increased.

Furthermore, no additional component parts for damping movement, such as for example springs, are necessary, which results in a low-maintenance construction.

A suitable arrangement of the at least one discharge valve and the at least one admission valve additionally makes it possible to generate a sealed air cushion present between the lower side of the receiving piston and the housing, which guarantees a damping effect of the receiving piston in the lowering process, in addition to the air resistance that occurs.

Gravity can act as the intake drive of the receiving piston in the housing of the device. In the usage position of the device the at least one receiving piston is thus guided substantially vertically movably.

The at least one admission valve guarantees a low-force raising of the at least one receiving piston in the device through a pressure equalization between an inner region and an outer region of the device during the raising process. The at least one discharge valve guarantees a damping of the downward movement of the at least one receiving piston during the lowering process of the receiving piston in the device through the pressure equalization.

As stated at the beginning, protection is also sought for a device with at least one, in particular electronic, cable.

As stated at the beginning, protection is also sought for a piece of furniture, in particular a table, with at least one such device.

It has proved to be advantageous for the at least one receiving piston to be arranged in the housing via at least one clearance fit. Preferably, the at least one clearance fit is formed substantially fluid-tight between an inner wall of the housing and at least one lateral surface of the at least one receiving piston.

In this context, a substantially fluid-tight clearance fit means that there is a lateral play between the at least one receiving piston and the housing only in as much as the raising and lowering process of the at least one receiving piston in the housing can be performed without any effort in addition to gravity being necessary and an airflow from and/or into the region between the lower side of the at least one receiving piston and the housing is generated substantially only via the admission valves and discharge valves provided for this.

A low-friction vertical displacement of the at least one receiving piston in the housing of the device is thus made possible with a simultaneously air-tight seal between the at least one receiving piston and the housing.

It has proved to be favorable that the inner wall is formed geometrically corresponding to the at least one lateral surface of the at least one receiving piston.

A separate guiding between the at least one receiving piston and the housing can thereby be dispensed with. Further, an undesired entry and/or exit of air between the lower side of the at least one receiving piston and the housing is particularly favorably prevented. In addition, a lower-maintenance device is made possible.

If the at least one receiving piston is guided via at least one rail arrangement and/or at least one rolling body system in the housing, a particularly low-force raising and lowering of the at least one receiving piston in the housing is made possible.

According to an advantageous embodiment of the invention, at least one sealing element is arranged between the inner wall and the at least one lateral surface of the at least one receiving piston.

At least one sealing element on the receiving piston, for example in the form of a piston ring, can particularly favorably prevent an air exchange via the at least one clearance fit.

It has proved to be favorable that the housing is formed in the form of at least one shaped tube, preferably closed on an underside.

The manufacturing process, as well as the installation of the housing, is thereby made easier and made possible in a low-cost manner. In addition, the geometry of the at least one receiving piston can be matched particularly easily to the geometry of the housing as a shaped tube.

Through a housing closed on the underside, an air cushion can form which develops through a lowering of the at least one receiving piston.

However, it is generally also possible for the housing to have an opening on the underside or to be formed in the form of a shaped tube that is open on the underside. In this embodiment the at least one receiving piston is not damped by the air cushion that forms. Here, the at least one admission valve can be arranged for example on a lower side of the at least one receiving piston and/or on a lower region of the housing.

According to an advantageous embodiment of the invention, the at least one admission valve and/or the at least one discharge valve is formed in the form of a non-return valve.

A non-return valve makes a flow of air possible only in one direction, as the airflow in the opposite direction is effectively prevented.

According to an advantageous design of the invention, the at least one admission valve and/or the at least one discharge valve is arranged on a lower region of the housing.

A low arrangement of the at least one discharge valve makes it possible for the at least one receiving piston to be able to be lowered deep in the housing and thus for a long cable length to be stowable in the device.

However, the discharge valve should not be arranged too low, in order still to be able to generate a formation of a damping air cushion—for example above the at least one admission valve in the usage position of the device.

An arrangement of the at least one admission valve as low as possible on the housing makes it possible for air to be able to flow, unimpeded, from the outer region into the housing in the region below the at least one receiving piston during the entire raising process.

It is advantageously provided that the at least one admission valve is arranged on the lower side of the at least one receiving piston.

An arrangement of the at least one admission valve as low as possible on the receiving piston makes it possible for air to be able to flow, unimpeded, from the outer region into the housing in the region below the at least one receiving piston during the entire raising process.

Advantageously, the at least one cable can be secured against a lowering of the receiving piston in a second position outside the housing via a cable brake.

Through the cable brake, the cable is fixed at a first end immovably relative to the housing and an undesired lowering of the cable into the device is prevented. The cable brake can block the cable in the pulling-out or pulling-in direction or bidirectionally.

The cable brake can affect both the raising process and the lowering process through the additionally occurring frictional force between cable and cable brake during the raising and/or lowering process.

It has proved to be favorable that at least one cover is arranged on an upper side of the at least one receiving piston and/or on the device.

A cover on the receiving piston and/or the device makes it possible for dirt, such as dust for example, to be prevented from getting in and for a visually appealing appearance of the device to be guaranteed to a high degree in the case of a raised receiving piston.

In addition, the at least one cable can be guided through the cover with regard to the contact on the deflection roller and/or the entry into the cable retractor for example through openings adapted to the at least one cable.

The shape of the cover is generally as desired. However, a shape adapted to the dimensions of the receiving piston and/or the device, which has lateral cutouts for the at least one cable to enter and/or exit from the receiving piston, is particularly preferred. However, it is also possible for the cable to enter and/or exit for example directly via the inner wall of the housing.

According to an advantageous embodiment of the invention it is provided that the at least one admission valve is arranged on the underside of the housing for admitting air substantially without resistance and that the at least one admission valve seals the housing against a discharge of air.

In the case of a raising process of the receiving piston, the at least one admission valve ensures a sufficient supply of air, with the result that the user essentially only has to compensate for the weight of the receiving piston, the deflection roller and the cable with a pulling force.

As the admission valve seals the housing against a discharge of air, it is guaranteed that air can flow off during a lowering process of the receiving piston substantially only via the discharge valve provided for this.

It has proved to be advantageous for the at least one discharge valve to be arranged on a lower region of a lateral surface of the housing for discharging air and for the at least one discharge valve to seal the housing against an admission of air.

Through the arrangement of the at least one discharge valve, a discharge of air necessary for the lowering process is guaranteed up to the point that the receiving piston conceals the at least one discharge valve.

As the at least one discharge valve seals against an admission of air, during the raising process substantially air is only supplied to the housing via the admission valve provided for this.

An advantageous variant is that due to gravity the at least one receiving piston can be lowered in the housing, preferably with the at least one cable located therein and guided around the at least one deflection roller.

As the weight of the receiving piston, the deflection roller and an exposed cable guarantees a vertical lowering into the housing, no additional effort of the user is necessary in order to stow an unneeded cable length in the housing.

As the cable can be lowered in the housing with the receiving piston, there is an aesthetically appealing device in which the unneeded cable length is concealed by the housing.

According to an advantageous design of the invention it is provided that at least one drive for lowering and/or raising the at least one receiving piston in the housing, preferably with the at least one cable located therein and guided around the at least one deflection roller, is provided.

The at least one drive makes it easier to raise and/or lower the at least one receiving piston. This provides the user of the device with a more convenient operation, as less effort is needed for the usage.

It has proved to be advantageous for the at least one drive to be formed in the form of at least one energy storage mechanism and/or at least one air pump and/or with at least one magnet.

The arrangement of the drive is as desired here. A drive arranged between the lower side of the at least one receiving piston and the housing has proved to be particularly favourable. However, for example, a drive between the cover and the at least one receiving piston is also conceivable.

It is particularly preferred that a lowering of the at least one receiving piston in the housing can be slowed down via an air resistance, and preferably the air resistance can be set via the at least one discharge valve.

The air resistance here is composed of both the air resistance of the components involved in the lowering process and the airflow delimited by the at least one discharge valve in the outer region of the device.

A gentle lowering of the receiving piston is guaranteed by the air resistance, which particularly favorably counteracts a vertical movement of the receiving piston due to the receiving piston inserted in an accurately fitting manner in the housing.

Through an adjustment of the at least one discharge valve, a flow of air exiting from the housing can be controlled and thus the air resistance can be adapted to a desired lowering speed of the receiving piston taking into consideration the weight of the components involved in the lowering process.

In an embodiment of the invention, the lowering of the at least one receiving piston in the housing can be slowed down by an air cushion, wherein the air cushion is formed by a volume between the underside of the housing and the lower side of the at least one receiving piston when the at least one discharge valve is concealed.

The advantageous effect of the air cushion, which forms in the lowering process when the at least one discharge valve is concealed by the receiving piston, is a damping effect on the lowering receiving piston, which results in a braking process that is gentler on the components.

According to a preferred embodiment of the invention, the at least one receiving piston can be raised by a pulling on a second end of the at least one cable.

It is thereby made possible for the user to advance the receiving piston via the deflection roller located therein vertically from a lowered position into a raised position by a pulling movement on the cable and thus for more free cable length, for example for the connection of electronic devices, to be able to be provided.

It has proved to be favorable that the at least one cable is guided over the at least one deflection roller in at least one indentation, preferably in the form of a substantially semi-circular groove.

Through a guiding of the cable in an indentation, a slipping of the cable on the deflection roller is counteracted and the cable is effectively prevented from slipping off the deflection roller.

Furthermore, a position in which the cable detaches from the deflection roller is defined and makes it possible to arrange several deflection rollers next to each other in a device, without the cables becoming tangled.

Further, preferably a sliding friction and/or a static friction of the at least one receiving piston during the lowering and/or raising and/or in a stationary position of the at least one receiving piston can be set via the at least one clearance fit of the at least one receiving piston in the housing.

Through the accuracy of fit, a mobility of or, respectively, a necessary force for moving the receiving piston in the housing can thus be controlled.

Alternatively, it is possible for a ratio of a diameter of the at least one deflection roller and a cable thickness to lie in the range of from 5 to 50, preferably in the range of from 10 to 20.

However, a friction coefficient between the at least one receiving piston and the housing can also be set via a suitable choice of the materials of the at least one receiving piston and/or housing. Plastics such as, for example, polytetrafluoroethylene have proved to be suitable. In general, however, the friction coefficient can also be influenced by a coating of the components.

Through a high ratio, a radius of curvature in relation to the cable located thereon is large enough not to deform the cable in such a way that a life of the cable is reduced. Through a low ratio, material of the components is saved, whereby both the weight and the costs of the construction are reduced. Through the ratio between 5 and 50, allowance is made for both advantages and a compromise favorable for the device is guaranteed.

According to an advantageous design of the invention, a first end of the at least one cable crosses the second end of the at least one cable above the at least one deflection roller.

In the state of the art, a cable end is guided out of the housing over a very narrow radius. The solution with crossing cable ends here provides less cable wear, as the elastic deformation of the cable between the at least one deflection roller and an exit from the housing is reduced.

According to an advantageous embodiment of the invention, the at least one cable is arranged between the at least one deflection roller and the at least one receiving piston substantially over a half circumference of the at least one deflection roller.

A deflection substantially over a half circumference makes it possible to arrange several cables in a compact manner on the at least one deflection roller, as there is no need to provide space for several cable windings of a cable on the at least one deflection roller. In addition, the risk of the cable tangling and a resultant blocking of a vertical mobility of the at least one receiving piston in the housing is minimized.

Furthermore, a weight of the at least one deflection roller with the at least one cable arranged thereon remains constant in the case of a vertical movement of the receiving piston, as an identical cable length is always arranged on the at least one deflection roller over an entire housing length.

According to an advantageous design of the invention, the at least one cable can be detachably fastened to the housing in a first position, preferably outside the housing.

A detachable fastening has the advantage that the cable can be pulled out of the device in a desired direction on the side facing away from this detachable fastening by a pulling movement of a user, without also pulling cable located in front of the detachable fastening.

Analogously, during a lowering process of the cable only the cable length that is located on the side facing away from the detachable fastening is pulled into the device.

It has proved to be advantageous for the at least one device to be arranged in at least one recess and/or at least one foot of the piece of furniture.

The at least one device can thereby be concealed towards the outside and a more visually appealing piece of furniture results.

### BRIEF DESCRIPTION OF THE DRAWINGS

Further details and advantages of the present invention are explained in more detail in the following with the aid of the description of the figures with reference to the embodiments represented in the drawings. There are shown in:

FIG. 1a a cable retractor according to a first preferred embodiment with a cable, an admission valve arranged on a receiving piston, a discharge valve and the receiving piston in a low position, schematically represented in a view from the front and from the side with visible internal contours,

FIG. 1b a cable retractor according to a second preferred embodiment with a cable, a discharge valve, an admission valve arranged on a housing and a receiving piston in a low position, schematically represented in a view from the front and from the side with visible internal contours,

FIG. 2a the cable retractor according to the embodiment shown in FIG. 1a with the receiving piston in a partially raised position,

FIG. 2b the cable retractor according to the embodiment shown in FIG. 1b with the receiving piston in a partially raised position,

FIG. 3a the cable retractor according to the embodiment shown in FIG. 1a with the receiving piston in a high position,

FIG. 3b the cable retractor according to the embodiment shown in FIG. 1b with the receiving piston in a high position,

FIG. 4 a detail section of a lower region of the cable retractor according to the embodiment shown in FIG. 1b,

FIG. 5 a cable retractor according to a third preferred embodiment with a cable, a discharge valve, an admission valve arranged on a housing as well as an admission valve arranged on a receiving piston in a perspective view with visible internal contours,

FIG. 6a a piece of furniture in the form of a table with two cable retractors in a perspective schematic view,

FIG. 6b a piece of furniture in the form of a modular construction insert with a cable retractor in a perspective schematic view.

### DETAILED DESCRIPTION OF THE INVENTION

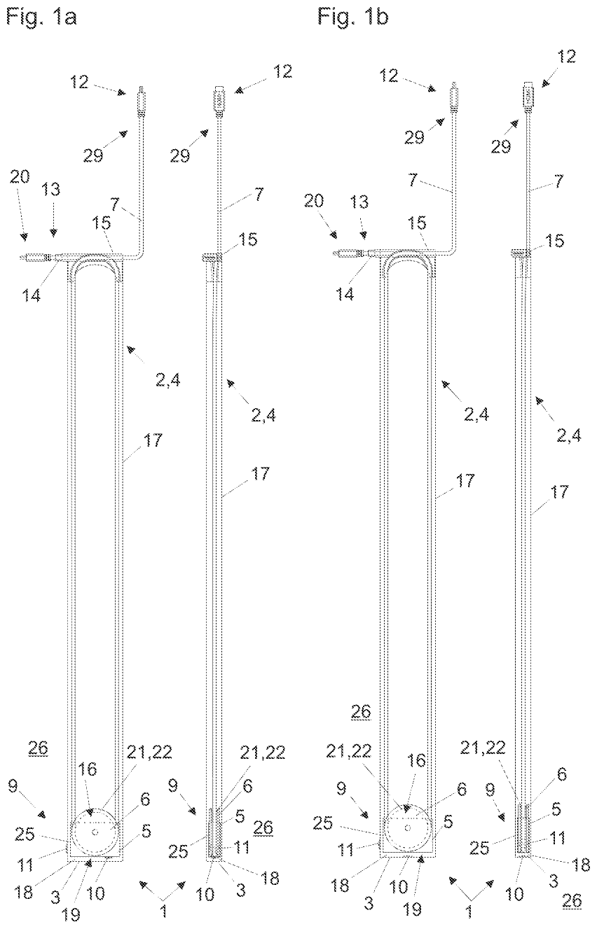

FIG. 1a shows a device 1 in the form of a cable retractor 1, comprising a housing 2 in the form of a shaped tube 4 closed on an underside 3, a receiving piston 5 arranged in an accurately fitting manner in the housing 2 and a deflection roller 6 mounted axially rotatably in the receiving piston 5.

The cable retractor 1 is represented in two views, rotated by 90 degrees about a vertical axis.

The position of the discharge valve 11 on the housing 2 determines the size of a damping air cushion 18 in combination with the geometry of the lower side 19 of the receiving piston.

The type of the admission valve 10 and of the discharge valve 11 is generally as desired. However, a non-return valve 34 is particularly preferred as a flow of air is made possible only in one direction.

A cover 15 is arranged on the cable retractor 1 and has two openings for the cable 7 to enter into and, respectively, exit from the cable retractor 1. However, a cover 15 can also be arranged on an upper side 16 of the receiving piston 5.

The cable 7 is guided over the at least one deflection roller 6 in at least one indentation 21, wherein the indentation 21 is formed in the form of a semi-circular groove 22.

The cable 7 can be detachably fastened in a first position 12 outside the housing 2 and secured against a lowering of the receiving piston 5 in a second position 13 outside the housing 2 via a cable brake 14 (arranged to the left of a cover 15 in the representation).

The cable retractor 1 is located in a substantially completely lowered position in the shaped tube 4, wherein this corresponds substantially to the lowest position of the receiving piston 5.

The receiving piston 5 can be raised by a pulling on a second end 20 of the cable 7. The force fit is provided for example by a blocking of the cable brake 14 or a fastening of the first end 29 of the cable, wherein the deflection roller 6 is raised against gravity vertically upwards in the housing 2 by a pull on the second end 20 via the guiding of the cable 7 around the substantially half circumference 8. Through a mounting of the deflection roller 6 on the receiving piston 5, the latter is also manoeuvred in a vertical direction—guided along an inner wall 17a (not represented for the sake of clarity).

A first end 29 of the cable 7 crosses the second end 20 of the cable 7 above the deflection roller 6 and protects the cable 7 through a smaller curvature of the cable 7 during exit from the housing 2.

Once the device 1 has been put into operation, the cable 7 is guided around the deflection roller 6 into the housing 2 via the housing side opposite the entry of the cable 7. The exit of the cable 7 from the housing 2 takes place after a guiding of the cable 7 around the substantially half circumference 8 of the deflection roller 6, because the cable 7 crosses the cable length already located in the housing 2 laterally offset and exits at the side opposite the entry position of the cable 7.

Putting the device 1 into operation can be effected in a user-friendly manner with a deflection roller 6 located outside the housing 2, wherein the deflection roller 6 is then inserted into the housing 2 again.

However, an installed device 1 with cable 7 can generally also comprise a guiding of the cable 7 without crossing cable lengths or another type of cable guiding.

FIG. 1b differs from FIG. 1a only in the arrangement of the admission valve 10. The admission valve 10 is arranged not on the lower side 19 of the receiving piston 5 but on the underside 3 of the housing 2.

The first end 29 of the cable 7 points in the direction of the image plane and the second end 20 of the cable 7 points normal to the image plane.

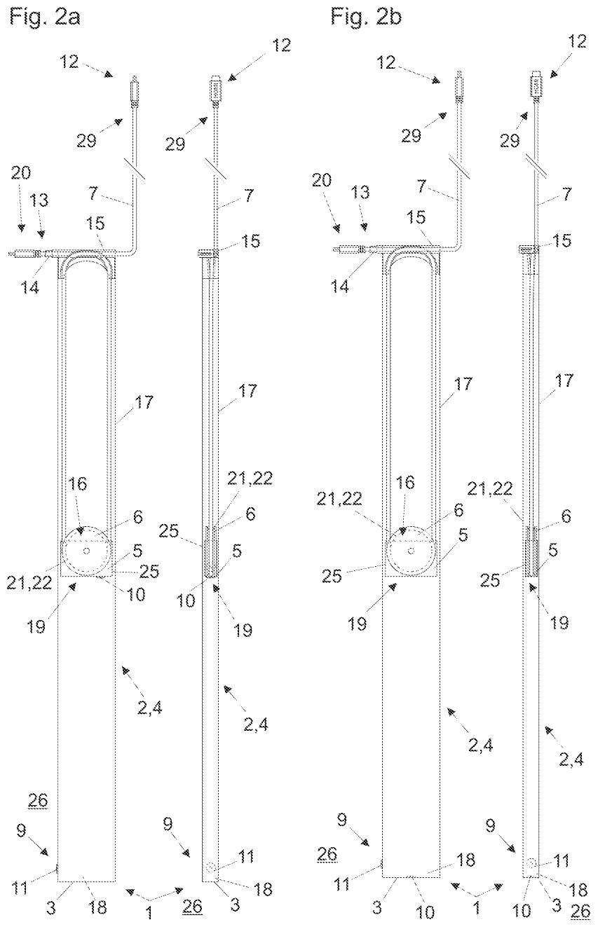

FIG. 2a shows the cable retractor 1 according to FIG. 1a. Due to gravity the receiving piston 5 can be lowered in the housing 2 with the cable 7 located therein and guided around the deflection roller 6. The mass of the receiving piston 5, the deflection roller 6 and the cable length that is located in the cable retractor 1 or substantially free above the housing 2 is accelerated by gravity in the direction of the underside 3 of the housing 2 and slowed down by the air underneath a lower side 19 of the receiving piston 5.

During a raising process of the receiving piston 5 via a pull on the cable 7, air flows via the at least one admission valve 10 from an outer region 26 of the device 1 into the space between the lower side 19 of the receiving piston 5 and the housing 2.

In the embodiment with an admission valve 10 arranged on the receiving piston 5 it can be necessary for the outer region 26 to be connected, for example via the openings in the cover 15, to a region in the housing 2—above the receiving piston 5—for air exchange. The orientation of the admission valve 10 can be adapted to the circumstances of the cable retractor 1.

During a lowering process of the receiving piston 5 caused by gravity, wherein the cable 7 is partially pulled into the housing 2 of the cable retractor 1, air flows via the at least one discharge valve 11 from a region between a lower side 19 of the receiving piston 5 and the housing 2 into the outer region 26 of the cable retractor 1.

The outer region 26 can be connected, for example via an opening in the cover 15, to an inner region of the cable retractor 1, which is arranged above the receiving piston 5 in the usage position, in order to guarantee the air exchange to a large degree in the case of an air-tight sealed underside 3 of the shaped tube 4.

The cable 7 fixes the receiving piston 5 in the vertical direction relative to the housing 2 via the deflection roller 6.

The cable retractor 1 is represented in a partially lowered position of the receiving piston 5 with a cable 7 partially pulled in on one side.

The lowering of the receiving piston 5 in the housing 2 can be slowed down by an air cushion 18, wherein the air cushion 18 is formed by a volume between the underside 3 of the housing 2 and a lower side 19 of the receiving piston 5 when the discharge valve 11 is concealed.

The position of the lower side 19 and of the underside 3 is defined by a usage position in which the at least one receiving piston 5 can be lowered vertically.

The underside 3 of the housing 2 can here relate to the housing 2 in the form of a shaped tube 4, or can generally denote a lower seal of the housing 2.

During the lowering process of the at least one receiving piston 5 in the housing 2 air can exit via the at least one discharge valve 11 into the outer region 26 of the device 1. In the position in which the lower side 19 conceals the at least one discharge valve 11, air is prevented from exiting from the region between the lower side 19 and the underside 3, whereby the air cushion 18 is formed.

The air cushion 18 is compressed by a further lowering of the at least one receiving piston 5 and brings about, because of a compression process, a damping force directed against a downward movement of the at least one receiving piston 5 onto the at least one receiving piston 5, which brings the at least one receiving piston 5 gently to a stop.

If the at least one discharge valve 11 is arranged closer in the direction of the underside 3, an air cushion 18 with a smaller extent forms, whereby a braking process of the at least one receiving piston 5 is performed more quickly. In the case of a fixed housing length, the cable length to be stowed in the cable retractor 1 is thereby increased, as the at least one receiving piston 5 can be lowered further in the housing 2. Conversely, a discharge valve 11 arranged higher on the housing 2 makes a more harmonic braking process possible in the lowering process of the at least one receiving piston 5 through an air cushion 18 with a larger extent.

FIG. 2b differs from FIG. 2a only in the arrangement of the admission valve 10.

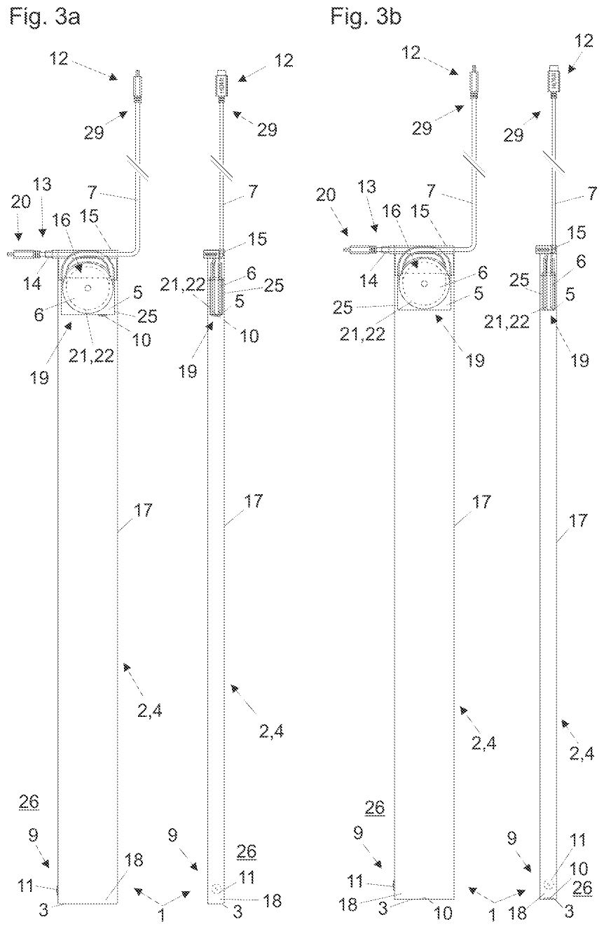

FIG. 3a shows the cable retractor 1 with a receiving piston 5, wherein the receiving piston 5 is arranged just short of its highest position in the housing 2.

A lowering of the at least one receiving piston 5 in the housing 2 can be slowed down via an air resistance, wherein the air resistance can be set via the discharge valve 11.

The quantity of air volume flowing out per unit of time can be adjusted via the discharge valve 11. The air resistance forming, which acts in a braking manner on the lowering movement of the receiving piston 5, can be controlled thereby.

An arrangement of the at least one discharge valve 11 on the underside 3 is likewise possible, but in this design embodiment the receiving piston 5 is slowed down in its lowering process via the air resistance of the lowering components in the housing and the delayed flow of the air out of the at least one discharge valve 11, and an air cushion 18 is not formed.

A small amount of sliding friction, which arises during a lowering process of the receiving piston 5, can likewise damp the movement of the receiving piston 5. However, the sliding friction is not to inhibit the movement of the receiving piston 5 and is not to require a large effort during the movement of the receiving piston 5.

If, in the lowering process, the receiving piston 5 interacts with the air cushion 18 forming as a result, the air cushion 18 has a damping effect on the vertical movement of the receiving piston and causes a gentle stopping of the receiving piston 5 without abrupt application of force on the components involved in the movement.

FIG. 3b differs from FIG. 3a only in the arrangement of the admission valve 10.

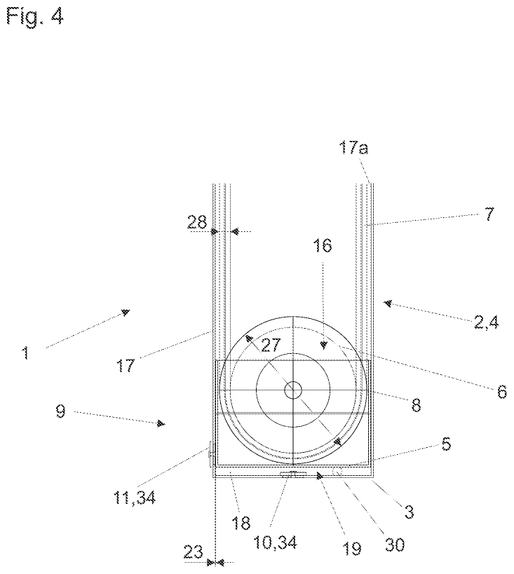

FIG. 4 shows a detail of the cable retractor 1 according to FIG. 1b represented enlarged.

The receiving piston 5 is guided in the housing by a suitable fit, wherein the fit is chosen such that a raising and lowering of the receiving piston 5 in the housing 2 is guaranteed without increased effort and without undesired exit and entry of air between the lower side 19 of the receiving piston 5 and the housing 2 in the direction of an outer region 26. However, the receiving piston 5 in the housing 2 can generally also be guided for example by a rail arrangement or another type of guiding system such as rolling bodies between receiving piston 5 and housing 2.

The shape of the lower side 19 is generally as desired. The lower side 19 can be designed for example concave or convex.

The lateral surface 25 of the receiving piston 5 is designed geometrically corresponding to the inner wall 17a. However, the guiding of the receiving piston 5 can also be implemented via a rail arrangement (not represented) and/or a rolling body system in the housing 2.

The at least one deflection roller 6 can be arranged completely or in regions in the at least one receiving piston 5 or outside on the at least one receiving piston 5. The at least one deflection roller 6 can be connected, for example via separate bearings, to the at least one receiving piston 5.

The embodiment in which the at least one deflection roller 6 protrudes freely from the at least one receiving piston 5 via an axial mounting in regions is particularly preferred, as the weight of the at least one receiving piston 5 can be reduced thereby.

A cable 7 is arranged between the deflection roller 6 and the receiving piston 5 substantially over a half circumference 8 of the deflection roller 6.

The type of cable 7 is generally as desired. However, it is particularly preferably an electronic cable 7 for powering electronic devices.

An admission valve 10 for admitting air and a discharge valve 11 for discharging air are arranged on a lower region 9 of the housing 2.

The side on which the at least one discharge valve 11 is arranged on the housing 2 is as desired.

The admission valve 10 on the underside 3 of the housing 2 is arranged for admitting air substantially without resistance and the admission valve 10 seals the housing 2 against a discharge of air.

The discharge valve 11 is arranged on a lower region 9 of a lateral surface 17 of the housing 2 for discharging air and the discharge valve 11 seals the housing 2 against an admission of air.

Both the admission valve 10 and the discharge valve 11 are formed as non-return valves 34.

A sliding friction and/or a static friction of the at least one receiving piston 5 during the lowering and/or raising can be set via an accuracy of fit of the receiving piston 5 in the housing 2.

The accuracy of fit indicates the lateral distance present between the receiving piston 5 and the housing 2. If the distance present is smaller, the sliding friction and static friction acting between the receiving piston 5 and the housing 2 also increases. If, on the other hand, the distance present is larger, the vertical movement of the receiving piston 5 in the housing 2 brings about a smaller sliding friction and static friction, as the interaction of the contacting surfaces turns out to be less than in the case of a smaller distance present.

It can also be provided that the sliding friction and/or the static friction of the receiving piston 5 in the housing 2 can be set via a distance between the cable 7 guided around the deflection roller 6 and the receiving piston 5 and/or a condition of a cable jacket.

The condition of the cable jacket causes, through the material-specific characteristics, a specific sliding friction coefficient and a specific static friction coefficient, which can be chosen to be larger or smaller via the material of the cable jacket.

A ratio of a diameter 27 of the at least one deflection roller 6 and a cable thickness 28 in the region is approximately 15. The ratio of approximately 15 is favourable for a cable retractor 1 with both a small mass and a cable guiding in which the cable 7 is not subjected to the risk of damage due to high deformations.

There is a clearance fit 23 which has a small lateral play between the receiving piston 5 and the inner wall 17a. This lateral play makes the vertical movement of the receiving piston 5 possible, without having to overcome a high friction force between the receiving piston 5 and the housing 2. However, the lateral play is not large enough to allow air to flow unimpeded from the lower side 19 into the outer region 26 of the device. An unimpeded air exchange can cause an undesired lowering process of the receiving piston 5.

A sealing element 24 (not represented for the sake of clarity) between the receiving piston 5 and the inner wall 17a can additionally prevent air from exiting from the region between the lower side 19 and the underside 3.

For the additional damping of the lowering process of the receiving piston 5, a damping element 30 is arranged between the lower side 19 of the receiving piston 5 and the underside 3 of the housing 2. In general, several damping elements 30 can also be present. A condition of the damping element 30 is generally as desired and can be formed for example in the form of an elastically easily deformable material and/or comprise a fluid store.

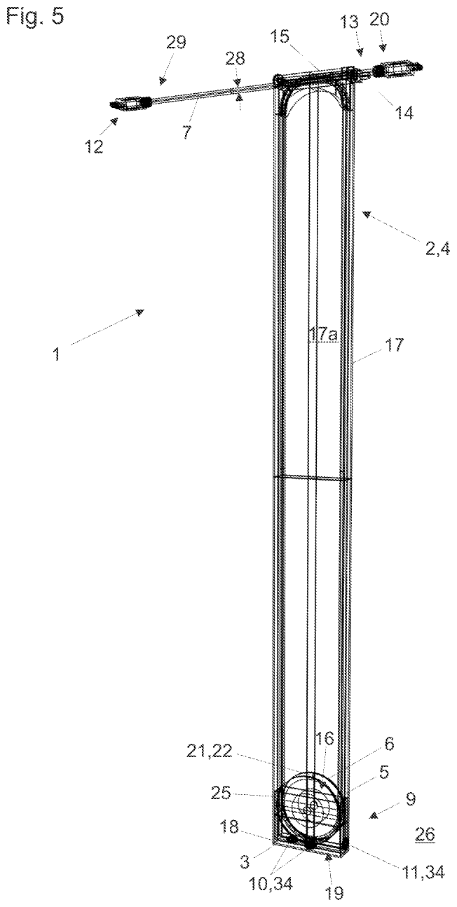

FIG. 5 shows a cable retractor 1 with two admission valves 10, wherein one admission valve 10 is arranged on the lower side 19 of the receiving piston 5 and one admission valve 10 is arranged on the underside 3 of the housing 2 in the form of a shaped tube 4 closed on the underside 3. An air exchange from an outer region 26 into the region between the underside 3 and the lower side 19 is particularly favourable as a result. Air can exit via the cover 15 into the outer region 26 from a region between the upper side 16 of the receiving piston 5, and vice versa.

The shaped tube 4 can generally be formed in one piece or composed of several shaped tube sections, as is shown in this embodiment. The shaped tube 4 can also have a convex or concave shape in regions or completely. The shaped tube 4 can have for example a rectangular, circular, ellipsoidal or polygonal cross section.

The shape of the deflection roller 6 is generally as desired. For example, the deflection roller can be provided with radial support struts or be formed continuous.

Through a rotatable mounting of the deflection roller 6, substantially no sliding friction between the cable 7 and the deflection roller 6 acts during the vertical movement of the receiving piston 5 due to a rotatability of the deflection roller 6, as a result of which the life of the cable 7 is increased.

The deflection roller 6 is arranged on the receiving piston 5 via two rotatable mountings. However, the deflection roller 6 can generally also be arranged on the receiving piston 5 for example via a pivot bearing or an axle.

The cable retractor 1 comprises a discharge valve 11 in the form of a non-return valve 34, wherein the discharge valve is arranged on a lower region 9 of the housing 2.

Through the admission valve 10 on the underside 3 of the housing 2, an adjustment of the inflowing airflow during the raising process of the receiving piston 5 in the housing 2 is also made possible in the installed state of the cable retractor 1.

As a support for the lowering process of the receiving piston 5 caused by gravity, at least one drive (not represented for the sake of clarity) can be provided in the form of at least one energy storage mechanism and/or at least one air pump and/or with at least one magnet. The at least one drive can also assist the raising process of the receiving piston 5 against gravity. A smaller effort for moving the receiving piston 5 is guaranteed thereby.

The at least one drive can also be used for a horizontal or slanting usage position of the cable retractor 1. In the horizontal usage position, it is essentially not gravity that acts during the lowering process and raising process of the receiving piston 5, but the at least one drive. In the case of a slanting usage position the lowering process and/or the raising process of the receiving piston 5 can be assisted by the at least one drive. However, a slanting usage position without a drive is also possible.

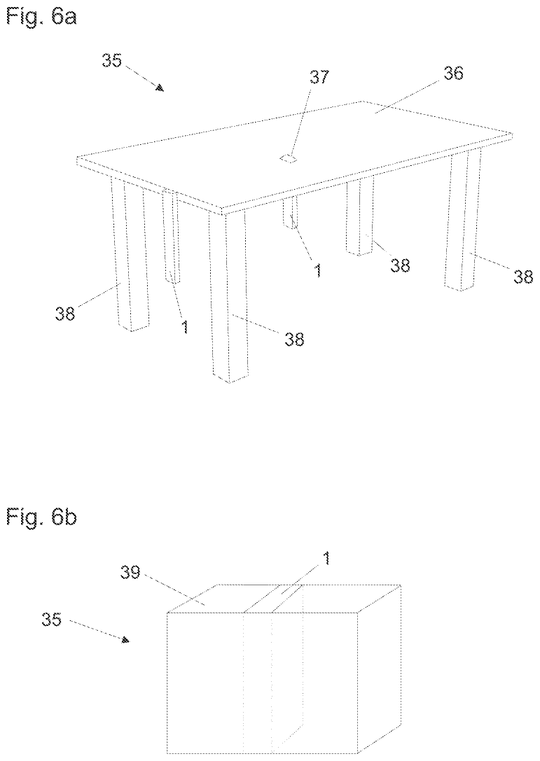

FIG. 6a shows a piece of furniture 35 in the form of a table 36 with two cable retractors 1. One cable retractor 1 is arranged in a recess 37 of the table 36. The position of the cable retractor 1 on the piece of furniture 35 is generally as desired.

The second cable retractor 1 is arranged without a recess 37 on a side of the piece of furniture 35. However, the cable retractor 1 can also be arranged in a foot 38 of the table 36 and/or replace the foot 38 of the table 36. The cable retractor 1 can be arranged concealed in the piece of furniture 35 or on the outside.

FIG. 6b shows a cable retractor 1 in a piece of furniture 35 in the form of a modular construction insert 39. Several cable retractors 1 can also be arranged on the modular construction insert 39. This piece of furniture 35 can be used individually in a furniture group in order to be able to respond to the specific needs of the space, to necessarily accessible cable lengths in the space as well as to cable lengths present in the cable retractor 1 with the position of the piece of furniture 35.

The cable retractor 1 can generally also be integrated in a wall and/or a cable channel. The cable retractor 1 can generally also be arranged for example in a standard lamp or decorative objects in the space. The cable retractor 1 can also be arranged for example in mobile implements such as a stand for a mobile microphone or be used for connection cables for mobile speakers.

The cable retractor 1 can also generally act as a pull-out for charging cables and/or USB cables in pieces of furniture 35, kitchens or further rooms. The cable retractor 1 can also be provided in charging columns for mobile phones, tablet computers, headphones, computers in the private and/or public sphere. Unneeded cable lengths can thus be stowed in the housing in an aesthetically appealing manner and a reduced safety risk for risk groups such as children or pets is additionally provided by the cable retractor 1.

### LIST OF REFERENCE NUMBERS

Device (1)
Housing (2)
Underside (3)
Shaped tube (4)
Receiving piston (5)
Deflection roller (6)
Cable (7)
Half circumference (8)
Lower region (9)
Admission valve (10)
Discharge valve (11)
First position (12)
Second position (13)
Cable brake (14)
Cover (15)
Upper side (16)
Lateral surface (17) of the housing
Inner wall (17a)
Air cushion (18)
Lower side (19)
Second end (20)
Indentation (21)
Groove (22)
Clearance fit (23)
Sealing element (24)
Lateral surface (25) of the receiving piston
Outer region (26)
Diameter (27)
Cable thickness (28)
First end (29)
Damping element (30)
Non-return valve (34)
Piece of furniture (35)
Table (36)
Recess (37)
Foot (38)
Modular construction insert (39)

1. A device for storing at least one cable, in particular cable retractor, comprising:
a housing,
at least one receiving piston guided in the housing, preferably rectilinearly,
at least one deflection roller, mounted axially rotatably on the at least one receiving piston, for guiding cables, and
at least one discharge valve for discharging air between a lower side of the at least one receiving piston and the housing into an outer region of the device,
wherein at least one admission valve is provided for admitting air from the outer region of the device into the region between the lower side of the at least one receiving piston and the housing.

2. The device according to claim 1, wherein:
the at least one receiving piston is arranged in the housing via at least one clearance fit, preferably wherein the at least one clearance fit is formed substantially fluid-tight between an inner wall of the housing and at least one lateral surface of the at least one receiving piston and/or
the inner wall is formed geometrically corresponding to the at least one lateral surface and/or
the at least one receiving piston is guided via at least one rail arrangement and/or at least one rolling body system in the housing and/or
at least one sealing element is arranged between the inner wall and the at least one lateral surface of the at least one receiving piston and/or
the housing is formed in the form of at least one shaped tube, preferably closed on an underside.

3. The device according to claim 1, wherein the at least one admission valve and/or the at least one discharge valve is formed in the form of a non-return valve.

4. The device according to claim 1, wherein the at least one admission valve and/or the at least one discharge valve is arranged on a lower region of the housing.

5. The device according to claim 1, wherein the at least one admission valve is arranged on the lower side of the at least one receiving piston.

6. The device according to claim 1, wherein the at least one cable can be secured against a lowering of the receiving piston in a second position outside the housing via a cable brake.

7. The device according to claim 1, wherein at least one cover is arranged on an upper side of the at least one receiving piston and/or on the device.

8. The device according to claim 2, wherein the at least one admission valve is arranged on the underside of the housing for admitting air substantially without resistance and the at least one admission valve seals the housing against a discharge of air.

9. The device according to claim 1, wherein the at least one discharge valve is arranged on a lower region of a lateral surface of the housing for discharging air and the at least one discharge valve seals the housing against an admission of air.

10. The device according to claim 1, wherein due to gravity the at least one receiving piston can be lowered in the housing, preferably with the at least one cable located therein and guided around the at least one deflection roller.

11. The device according to claim 1, wherein at least one drive is provided for lowering and/or raising the at least one receiving piston in the housing, preferably with the at least one cable located therein and guided around the at least one deflection roller and/or wherein the at least one drive is formed in the form of at least one energy storage mechanism and/or at least one air pump and/or with at least one magnet.

12. The device according to claim 1, wherein a lowering of the at least one receiving piston in the housing can be slowed down via an air resistance, wherein it is preferably provided that the air resistance can be set via the at least one discharge valve.

13. The device according to claim 2, wherein the lowering of the at least one receiving piston in the housing can be slowed down by an air cushion, wherein the air cushion is formed by a volume between the underside of the housing and the lower side of the at least one receiving piston when the at least one discharge valve is concealed.

14. The device according to claim 1, wherein:
the at least one receiving piston can be raised by a pulling on a second end of the at least one cable and/or
the at least one cable is guided over the at least one deflection roller in at least one indentation, preferably in the form of a substantially semi-circular groove.

15. The device according to claim 2, wherein a sliding friction and/or a static friction of the at least one receiving piston during the lowering and/or raising and/or in a stationary position of the at least one receiving piston can be set via the at least one clearance fit of the at least one receiving piston in the housing.

16. The device according to claim 1, wherein a ratio of a diameter of the at least one deflection roller and a cable thickness lies in the range of from 5 to 50, preferably in the range of from 10 to 20.

17. The device according to claim 1, wherein:
a first end of the at least one cable crosses the second end of the at least one cable above the at least one deflection roller and/or
the at least one cable is arranged between the at least one deflection roller and the at least one receiving piston substantially over a half circumference of the at least one deflection roller and/or
the at least one cable can be detachably fastened on the housing in a first position outside the housing.

18. The device according to claim 1 with at least one, in particular electronic, cable.

19. A piece of furniture, in particular table, with at least one device according to claim 1.

20. The piece of furniture according to claim 19, wherein the at least one device is arranged in at least one recess and/or at least one foot of the piece of furniture.
